(19) United States
(12) Patent Application Publication
(10) Pub. No.: US 2022/0250179 A1
(43) Pub. Date: Aug. 11, 2022

(54) DEVICE AND METHOD FOR PROCESSING A CONDUIT

(71) Applicant: Callidus Capital B.V., Heerenveen (NL)

(72) Inventor: Feitze VEENSTRA, Heerenveen (NL)

(21) Appl. No.: 17/624,732

(22) PCT Filed: Jul. 8, 2020
(86) PCT No.: PCT/NL2020/050445

§ 371 Date: Jan. 4, 2022

(30) Foreign Application Priority Data
Jul. 8, 2019 (NL) 2023460

(51) Int. Cl. B23D 21/02; B26D 3/00; F16L 1/028

(52) U.S. Cl. CPC B23D 21/02; F16L 1/028; B26D 3/001

(57) ABSTRACT

A first aspect provides a device for processing a conduit. The device comprises a cutting module to cut at least part of the conduit over a longitudinal axis of the conduit by creating a first cut line in the conduit substantially parallel to the longitudinal axis, a separation module arranged to separate a first part of the conduit on a first side of the first cut line from a second part of the conduit on a second side of the first cut line and a transportation module for driving the conduit along the cutting module and the separation module. The transportation module is used to pull the piping of the ground, irrespective of whether the piping is in the ground positioned in a vertical way, a horizontal way or under an angle. Hence, the transportation module may be implemented as an extraction module for extracting the piping from the ground.

### TECHNICAL FIELD

The various aspects and implementations thereof relate to a method of processing piping. More in particular, the various aspects and implementations relate to removing piping from the ground, for example from a well for winning oil or other natural resources.

### BACKGROUND

Piping for collecting oil from a well or piping for transportation of oil or other resources comprises multiple segments. The segments are connected to one another by means of welding, bolting by means of nuts and bolts, by means of connector members that are connected to two pipe segments by means of threads or other mechanical, chemical or physical bonding.

If well are exhausted or the exploitation of the wells is not expected to be feasible anymore in the future, for example due to a limit amount of resources available in the well, the well may be closed and abandoned. For the abandonment of wells, the production piping/production tubing is to be removed, for example in view of environmental considerations, further plugging of the well, (to get access with other tools) legislation, other, or a combination thereof.

For removing the piping, a rig—a tower/snubbing unit or hydraulic work over unit is used, the putting in place thereof is a significant effort. Furthermore, the separation of the various pipe segments takes significant amount of time because of disconnection of the connections,

### SUMMARY

It is preferred to provide a system that may be used for more efficiently processing piping in the process of well abandonment or pipeline removal.

A first aspect provides a device for processing a conduit. The device comprises a cutting module to cut at least part of the conduit over a longitudinal axis of the conduit by creating a first cut line in the conduit substantially parallel to the longitudinal axis, a separation module arranged to separate a first part of the conduit on a first side of the first cut line from a second part of the conduit on a second side of the first cut line and a transportation module for driving the conduit along the cutting module and the separation module.

The transportation module may be used to pull the piping of the ground, irrespective of whether the piping is in the ground positioned in a vertical way, a horizontal way or under an angle. Hence, the transportation module may be implemented as an extraction module for extracting the piping from the ground.

While the piping is being pulled out of the ground, the piping is directly cut and the cut parts are separated to allow convenient transportation, storage or other further processing of the cut piping.

Furthermore, the separation of the parts of the piping wall at either side of the cut line opens up the piping, which may allow for more convenient and/or more efficient cleaning.

Instead of traditional tubing installation and removal, this opens the way to continues tubing pulling instead of intermittently, without a need of having to decouple piping elements, as the couplings may be cut as well, in one continuous process. Furthermore, lifting of the whole pipe and in particular a lower end of a pipe segment to ground level is also eliminated.

In one implementation, the cutting module is arranged to create the first cut line inside the conduit. And advantage of this implementation is that the cutting module may be positioned such that any irregularities at the outside of the piping, like couplings for coupling pipe segments, do not provide obstacles for the cutting module.

In another implementation, the device comprises an elongate conduit guiding element arranged to be inserted in the conduit, wherein a first cutting sub-module of the cutting module is provided on the conduit guiding element. The conduit guiding element ensures that the piping is cut at the correct location.

In a further implementation, the separation module comprises a wedge shaped splitting element having a wedge point and wherein the conduit guiding element is at a proximal end connected the wedge point. By driving the cut piping towards the wedge, both parts of the piping on either side of the cut are forced to part. This allows, for example, to flatten the cut piping or, as another option, to fully separate different parts of the piping if two or more cuts are provided.

In yet another implementation, the cutting module is arranged to create a first cut line at at least part of the outside of the conduit. Such part may be a coupling or connector that couples two—or optionally more—pipe segments; by cutting the couplings, the segments are separated in one simple step. An advantage of this implementation is that a further implementation is possible, in which the cutting module only cuts the couplings connecting pipe segments and the pipe segments are left intact. As another option, also the pipe segments or the full piping is cut at the outside, either fully or through only part of the wall, in addition to or as an alternative to cutting from within.

Yet a further implementation comprises a flattening module arranged to flatten the separated conduit. Flattened piping is mostly more conveniently to store than curved piping. Furthermore, flattening may make cleaning of piping more efficient.

In again another embodiment, the flattening module comprises rollers positioned forming a curved trajectory for at least part of the separated conduit. Firstly, this allows for flattening of the piping segments without specifically exerting a forced to the piping: due to the piping following a curved trajectory, the piping is flattened. Second, a curved trajectory allows for a compact design.

Again a further embodiment comprises a sorting cutter, arranged to cut the separated conduit under an angle relative to the longitudinal axis.

Piping segments may be very long, whereas compact storage may be preferred.

A second aspect provides a method of processing a conduit. The method comprises cutting at least part of the conduit parallel to a longitudinal axis of the conduit by providing a first cut line parallel to the longitudinal axis and separating a first part of the conduit at a first side of the cut line from a second part of the conduit at a second side of the first cut line.

### BRIEF DESCRIPTION OF THE DRAWINGS

The various aspects and implementations thereof will now be discussed in further detail in conjunctions with drawings. In the drawings:

FIG. 1: shows a system for processing piping;

FIG. 2: shows a pipe splitter;

FIG. 3: shows the pipe splitter processing a pipe;

FIG. 4 A: shows a cross-section of the pipe splitter; and

FIG. 4 B: shows a detail of the cross-section.

### DETAILED DESCRIPTION

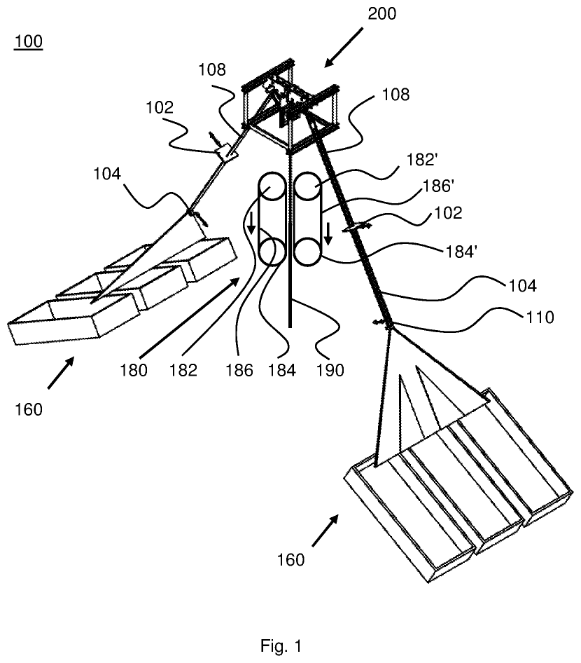

FIG. 1 shows a pipe processing system 100 as an implementation of the first aspect. The pipe processing system 100 comprises a pipe and pipe connector splitter 200 for splitting piping and its connectors 190 and two split pipe guides 108. On the pipe guides 108, downstream cutters 102 are provided for segmenting split pipe parts. At the end of the pipe guides, sorters end stops 104 are provided for stopping the strips from sliding down for length cutting. A turner or rocker turns the strip 90 degrees over the longitudinal axis of the cut pipe part. This allows the cut pipe part to pass the end stop en enter into the wipers to direct to a selected scrap bin, by two parallel wipers 110 is for guiding cut pipe parts to a specific bin 106 of the bins 106.

The pipe processing system 100 further comprises a pipe extractor 180 for extracting the piping 190 from the ground or well. In the implementation shown, the pipe extractor 180 comprises a first drive belt 186 and a second driven belt 186. The two belts 186 are biased towards the piping. The first drive belt 186 is driven by a left first wheel 182 and a left second wheel 184 and the second drive belt 186 is driven by a right first wheel 182′ and a right second wheel 184. By driving the wheels, the belts are driven. The belts are driven such that the part biased towards the piping 190 moves in the direction of the pipe splitter 200.

In another implementation, the pipe extractor 180 does not comprise a belt, but one or more wheels that are biased towards the piping 190 such that the wheels exert a force on the piping resulting in the piping 190 moving towards the pipe splitter 200. The wheels may be provided with a profile, like toothing, a rubber liner comprising a particular profile, other, or a combination thereof.

In yet another implementation, the piping 190 is fed to the pipe splitter in steps by means of a snubber. The snubber grips the piping 190 and moves it, for example by means of one or more hydraulic cylinders, towards the pipe splitter. For removal of pipe lines with a pulling cylinder with inner gripper, a remaining pipe piece may be used as anchor. In another implementation, these options may be combined.

Whereas in FIG. 1, the pipe processing system 100 is shown extracting a pipe in vertical direction, extraction of a horizontally oriented pipe may be envisaged as well.

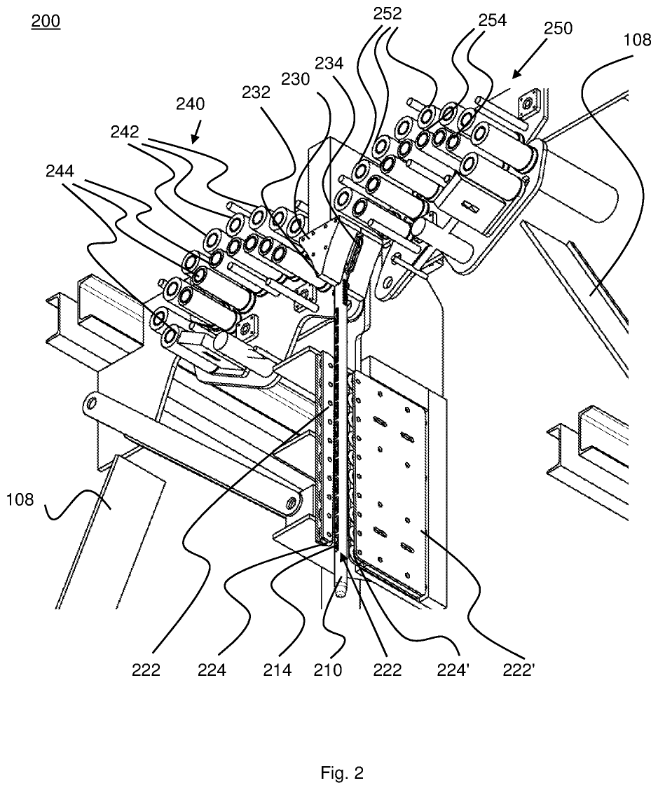

FIG. 2 shows the pipe splitter 200 in further detail. In the middle, a pipe guide 210 is shown arranged to have the piping 190 slid over it. The pipe guide 210 is at a distal end connected to a wedge 230 to split the cut or partial cut pipe , at the wedge point 232. In this implementation, the wedge is provided with rollers 234 to lower the friction on the wedge. In the embodiment depicted by FIG. 2, the piping 190 is split in two parts. In another embodiment, the piping 190 is split in three or more parts. In such embodiment, the wedge 230 may have a different shape, for example that of a pyramid with an amount of apex ribs equal to the amount of cut lines or a substantially conical or frusto-conical shape.

Left of the wedge 230, a first roller module 240 is provided. The first roller module 240 comprises a set of first upper rollers 242 and a set of first lower rollers 244. All or some of the first rollers may be drivable by a driving unit like an electromotor, a hydraulic motor or other providing similar functionality. Only one or more first upper rollers 242 may be driven and/or only one or more of the first lower rollers 244 may be driven.

Right of the wedge 230, a second roller module 250 is provided. The second roller module 240 comprises a set of second upper rollers 252 and a set of second lower rollers 254. All or some of the second rollers may be drivable by a driving unit like an electromotor, a hydraulic motor or other providing similar functionality. Only one or more second upper rollers 252 may be driven and/or only one or more of the second lower rollers 254 may be driven. The rollers of the roller modules are positioned forming a curved trajectory. The upper rollers and the lower rollers may be pressed to one another, under a bias. Alternatively, they are not pressed to one another. The curved trajectory may be followed by a substantially straight trajectory for cut piping provided by the roller. This straight trajectory functions as a straightener arranged to provide flat and straight pipe segments. Alternatively, this final trajectory is slightly curved in a direction opposite to the earlier curve for providing the straightening function.

In the pipe guide 210, an inner cutting module 212 is provided. The inner cutting module 212 comprises a set of inner cutting wheels 214. The inner cutting wheels 214 are arranged to cut the piping 190 by providing a cut line in the piping 190, the cutline lying in a cut plane perpendicular to a roller plane in which the first roller module 240 and the second roller module 250.

The inner cutting module comprises in this implementation pairs of inner cutting wheels 214, of which pairs a first inner cutting wheel 214 extends from the pipe guide 210 opposite from where a second inner cutting wheel 214 of the pair extends from the pipe guide 210. In another implementation, inner cutting wheels extend from only one side of the pipe guide 210.

Adjacent to the inner cutting module 214, a first outer cutting module 222 is provided at a first side of the inner cutting module 214 at a second side of the inner cutting module 214, opposite to the second side, a second outer cutting module 222′ is provided. The first outer cutting module 222 comprises first outer cutting wheels 224 and the second outer cutting module 222′ comprises second outer cutting wheels 224′. Outer cutting wheels 224 are preferably positioned adjacent to inner cutting wheels 214 or in the same cutting plane. The cutting wheels—inside and/or outside—are preferably greased or otherwise provided with a lubricant and/or provided with a coolant.

In the implementations above, the cutting modules are disclosed as comprising sequence of cutting wheels that provide a cut line with increasing depth as the piping proceeds through the pipe splitter. In other implementations, other cutting means may be used, including high pressure water jet cutters, plasma/laser cutters, wire cutters, grinding, milling, scrapping, a chisel, spark erosion, chemical erosion thermal lance, acetylene burner or other, or a combination thereof.

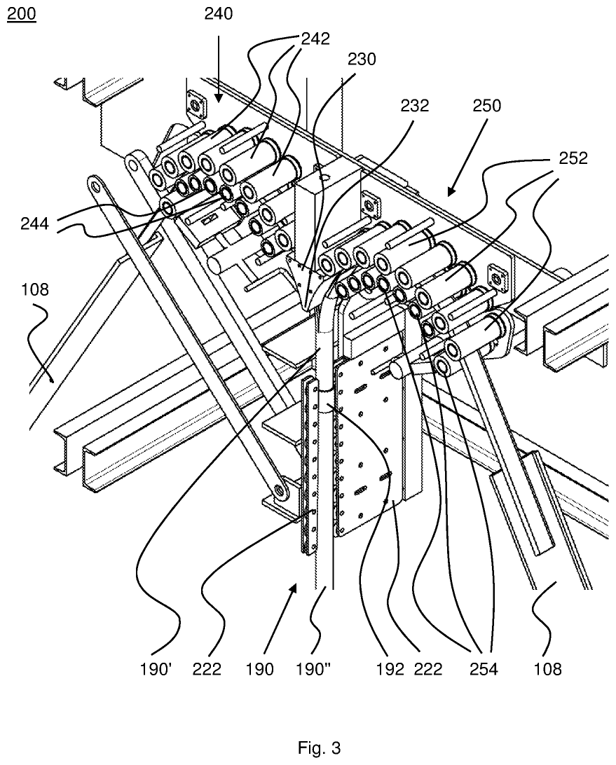

FIG. 3 shows the pipe splitter 200, with tubing 190 provided in the pipe splitter 200. The pipe guide 210 is not visible in FIG. 3, as it is inserted in the piping 190. The piping 190 as shown by FIG. 3 comprises a first pipe segment 190′ and a second pipe segment 190″. The first pipe segment 190′ and the second pipe segment 190″ are connected by means of a pipe coupling 192. The first pipe segment 190′ and the second pipe segment 190″ comprise threads an preferably outer threads at their opposite ends. The pipe coupling 192 has a thread arranged to engage with the threads of the pipe segments. The pipe coupling 192 preferably comprises inner threads and preferably has a wider outer diameter than the pipe segments.

From FIG. 3 can be seen that the piping 190 is cut by the inner cutting module 212 and the first outer cutting module 222 and the second outer cutting module 222′. The cut piping 190 is fed to the wedge 230 and in particular towards the wedge point 232. By exerting a force on the piping 190 towards the wedge point 232, the piping 190 is split in a first half and a second half.

The first half is led to the first roller module 240 and the second half is led to the second roller module 250. In an implementation in which at least some of the rollers are driven, the roller provide a force that allows for the cut piping to be pushed to the wedge point 232. Second, the rollers are arranged to flatten the first half and the second half. Whereas rollers are preferred for flattening the cut piping, other means for flattening like hammers may be used as well. In another implementation, the bending itself flattens the pipe. Optionally, the strips are straightened after the bending.

The wall of the first pipe segment 190′ may have been fully cut through or only severed or weakened by a cut line that does not extend from the inside to the outside of the first pipe segment 190′. In the latter case, the force exerted on the first pipe segment 190′ towards the wedge point 232 will result in breaking of the first pipe segment 190′ of the cut line that has been provided parallel to the longitudinal axis of the first pipe section 190′.

It is noted that whereas FIG. 2 and FIG. 3 show the wedge 230 having an actual wedge shape—or having a triangular prism shape, also other shapes may be used as a splitting member for separating two parts of the first pipe segment 190′ on either side of one or more cut lines.

Alternatively or additionally, the splitting or separating part of the pipe splitter 200 may comprise a pyramid or cut (frusto) pyramid shape, with three or more apex ribs—ribs from base to apex.

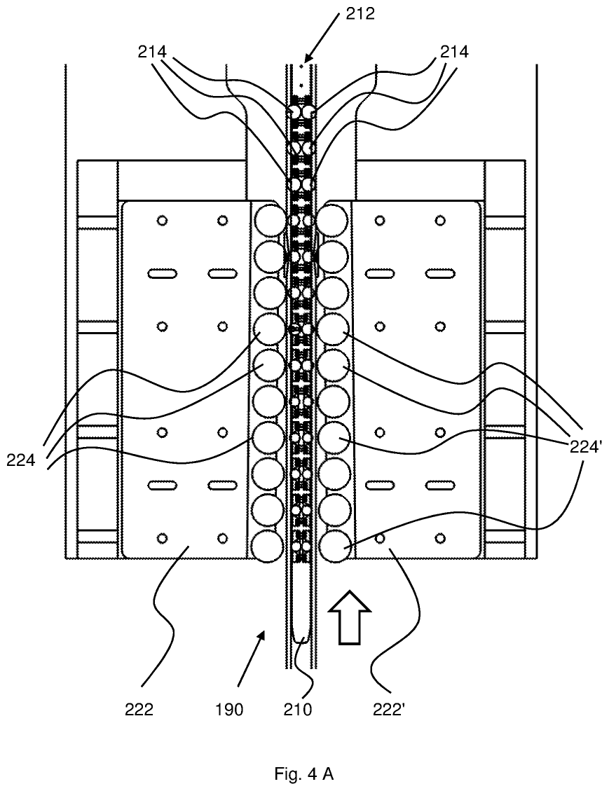

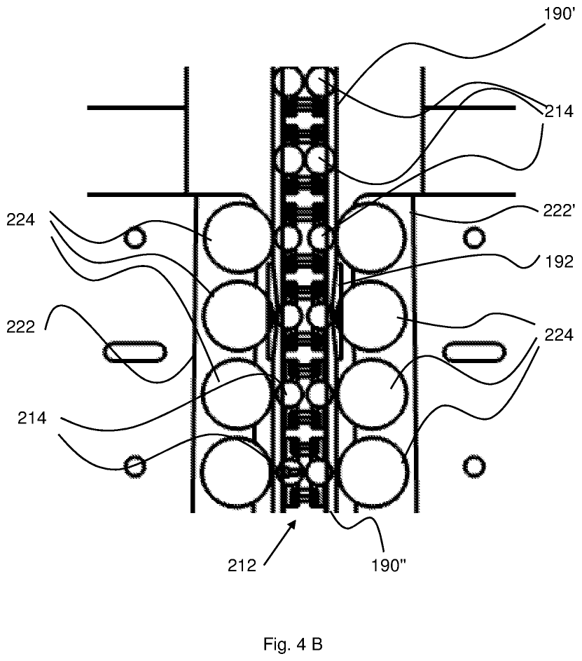

FIG. 4 A shows a cross-section of the inner cutting module 212, the first outer cutting module 222 and the second outer cutting module 222′ with the piping 190 provided over the pipe guide 210. FIG. 4 A shows that from the proximal point of the pipe guides—at the lower part of FIG. 4 A—towards the distal end of the pipe guide 210, the inner cutting wheels 214 protrude further from the inner cutting module 212.

At the proximal end of the inner cutting module 212, the inner cutting wheels 214 protrude only slightly from the pipe guide 210 to provide only a shallow cut line in the piping 190. At the distal end of the inner cutting module 212, the inner cutting wheels 214 protrude from the pipe guide 210 such that they fully cut thought the first pipe segment 190′. In another implementation, the distal inner cutting wheels 214 do not fully cut through the wall of the first pipe segment 190′, but far enough to make the first pipe segment 190′ split when driven to the wedge point 232. In yet another implementation, the distal cutting wheels 214 extend such from the pipe guide that they also cut through the pipe coupling 192.

FIG. 4 A also shows the outer cutting wheels protruding from the outer cutting modules. At the left, the first outer cutting module 220 is shown with first outer cutting wheels 224. At the right, the second outer cutting module 220′ is shown with second outer cutting wheels 224′.

At the distal end of the outer cutting modules 222, the outer cutting wheels 224 protrude such that they fully cut thought the pipe coupling 192. This is shown in further detail in FIG. 4 B. Preferably, the distal outer cutting wheels 242 also cut through the inner threads of the pipe coupling 192, if available. In one implementation, the outer cutting modules 222 cut the couplings 192, preferably fully, including the threads, and the inner cutting module 212 cut the pipe segments 190. In such implementations, each of the inner cutting module 212 and the outer cutting modules 222 has its specific functionality. Alternatively, all cutting is done by either the inner cutting module 212 or the outer cutting modules 222. In yet another implementation, at least one of the inner cutting module 212 and the outer cutting modules 222 cut both through the pipe segments 190 and the couplings 192. In particular if the outer cutting modules 222 cut through the threads of the couplings 192, they may cut through at least part of the outer wall of the pipe segments 190. In yet another implementation, distance between the outer cutting modules 222 and the pipe segments 190 may be modified such that the outer cutting modules 222 move closer to the pipe segments 190 when a coupling 192 is to be cut and they are moved away from the pipe segments 190 when no coupling is present at the outer cutting modules 222 as to prevent or reduce severing of an outer wall of a pipe segment 190. In the latter implementation, the pipe segments are not separated and optionally not flattened.

In another implementation, the distal outer cutting wheels 224 do not fully cut through the pipe coupling 192, but far enough to make the pipe coupling 192 split when driven to the wedge point 232. In yet another implementation, the distal cutting wheels 214 extend such from the pipe guide that they also cut through the first pipe segment 190′.

The pipe splitter 200 may be provided and operated with only the inner cutting module 212, only one or both the outer cutting module 222 or with all three cutting modules—or even more cutting modules.

In one implementation, only the first outer cutting module 222 and/or the second outer cutting module 222′ are provided, arranged to cut through the pipe coupling 192. In such implementation, the pipe coupling 192 may be split, either by widening the cut line if only one cut line is provided by a single outer cutting module. In other implementation, the pipe coupling 192 is cut by means of two or more cut lines and if the cuts are fully through, including the thread, the pipe coupling falls apart and disengages from the first pipe segment 190′ and the second pipe segment 190″. Operation of this implementation allows for automated segmentation of the piping 190, while keeping pipe segments intact.

In yet another implementation, the coupling 192 is cut in two or more parts, as described directly above an, additionally, the pipe segments 190′ and 190″ are provided with only one cut line over which the pipe segments 190′ and 190″ are opened. In this implementation, parts of the pipe segments 190′ and 190″ are separated and the pipe segments 190′ and 190″ are opened, preferably flattened in one piece per pipe segment. Advantages of this implementation are that only one discharge of cut pipe segments is required and that only one cutting module is required to cut the pipe segments.

In another implementation, only one cut line is provided parallel to the longitudinal direction of the piping 190, either fully through the wall of the piping 190 or not fully through, yet severing or weakening the wall of the piping 190 over a cut line. In this implementation, the pipe is split by separating first pipe part at one side of the cut line from a second pipe part at another side of the cut line. This may be executed by means of the wedge 230 or by means of another body providing wedging functionality, like a cone or truncated cone. If the pipe wall is only severed, it may be broken open over the cut line by means of the wedge or cone. Subsequently, the thus widened and cut pipe may optionally be flattened as discussed above.

In again another implementation, one, two or more cut lines are provided substantially parallel to the longitudinal axis of the piping 190. In this embodiment, the piping 109 is folded over the one, two or more cut lines and flattened. In one specific embodiment, the folding of the piping 190 thus cut may result in breaking over the cut lines, resulting in separation of the parts of the piping 190 over the cut lines. Other methods of separation may be applied as well, like driving over a wedge or the like as a splitter. In this implementation, the flattener—like the rollers, hammers, other, or a combination thereof—also provide the functionality of the splitter and a separate splitter is not required. Also other embodiments may be envisaged in which no separate splitter is required.

The system for processing piping or other conduits is particularly useful for processing piping used for exploitation of crude oil or natural gas wells. This means that the piping processed may comprise residue of the crude oil. And in other scenarios, the piping may comprise other material that may be hazardous for the environment. Therefore, it is preferred to provide a receptacle or collector below the splitter 200 as depicted by FIG. 1. The collector or receptacle comprises an opening for the piping and further surrounds the piping, preferably above the pipe extractor 180 and below the pipe splitter 200. With a gutter to the bins, the receptacle is also suitable for receipt and op the split couplings and guidance to the scrap bin.

1. A device for processing a conduit, the device comprising:
a cutting module arranged to cut at least part of the conduit over a longitudinal axis of the conduit by creating a first cut line in the conduit substantially parallel to the longitudinal axis;
a separation module arranged to separate a first part of the conduit on a first side of the first cut line from a second part of the conduit on a second side of the first cut line; and
a transportation module for driving the conduit along the cutting module and the separation module.

2. The device according to claim 1, wherein the cutting module is arranged to create the first cut line inside the conduit.

3. The device according to claim 2, further comprising an elongate conduit guiding element arranged to be inserted in the conduit, wherein a first cutting sub-module of the cutting module is provided on the conduit guiding element.

4. The device according to claim 3, wherein the separation module comprises a wedge-shaped splitting element having a wedge point and wherein the conduit guiding element is at a proximal end connected the wedge point.

5. The device according to claim 1, wherein the cutting module is arranged to create a first cut line at at least part of the outside of the conduit.

6. The device according to claim 5, wherein the cutting module comprises a second cutting sub-module arranged to provide the first cut line in coupling elements.

7. The device according to claim 1, wherein the cut line is a cut through a wall of at least part of the conduit.

8. The device according to claim 1 wherein the cutting module is arranged to create a second cut line in the conduit substantially parallel to the longitudinal axis and opposite to the first cut line.

9. The device according to claim 8, wherein the separation module is arranged to separate a first half of the conduit from a second half of the conduit, the halves being defined by the first cut line and the second cut line.

10. The device according to claim 1, further comprising a flattening module arranged to flatten the separated or cut conduit.

11. The device according to claim 10, wherein the separation module is arranged to separate a first half of the conduit from a second half of the conduit, the halves being defined by the first cut line and the second cut line and wherein the flattening module comprises a first flattening sub-module for flattening the first half and a second flattening sub-module for flattening the second half.

12. The device according to claim 10, wherein the flattening module comprises rollers arranged to exert a force on the separated conduit.

13. The device according to claim 10, wherein the flattening module comprises rollers are positioned forming a curved trajectory for at least part of the separated conduit and wherein further rollers are provided forming a further trajectory being straight or having a curved with an orientation opposite to the earlier curved trajectory for straightening flatted pipe segments.

14. The device according to claim 1, further comprising a sorting cutter, arranged to cut the separated conduit under an angle relative to the longitudinal axis

15. The device according to claim 1, wherein the transportation module comprises at least one belt or a wheel arranged to drive the conduit by transferring a motion of the belt of the wheel from the belt to the conduit.

16. The device according to 10, wherein the transportation module is comprised by the flattening module.

17. The device according to claim 16 wherein:
the flattening module comprises rollers arranged to exert a force on the separated conduit; or
the flattening module comprises rollers positioned forming a curved trajectory for at least part of the separated conduit and wherein, further rollers are provided forming a further trajectory being straight or having a curved with an orientation opposite to the earlier curved trajectory for straightening flatted pipe segments; and
rollers are arranged to drive the conduit by driving the rollers.

18. (canceled)

19. A method of processing a conduit, the method comprising:
cutting at least part of the conduit parallel to a longitudinal axis of the conduit by providing a first cut line parallel to the longitudinal axis; and
separating a first part of the conduit at a first side of the cut line from a second part of the conduit at a second side of the first cut line.

20. The method according to claim 19, wherein the conduit comprises segments having a first outer width connected by connectors having a second outer width wider than the first outer width, the method further comprising providing the first cut line to at least one connector and separating a first part of the connector at a first side of the first cut line from a second part of the connector at a second side of the first cut line.

21. The method according to claim 20, wherein the segments comprise an outer thread provided on at least a proximal end of the segment and the connectors comprise an inner thread arranged to engage with the outer thread and wherein the method further comprises cutting the connector to a depth that the inner thread is cut.
